(19) United States
(12) Patent Application Publication
(10) Pub. No.: US 2007/0126711 A1
(43) Pub. Date: Jun. 7, 2007

(54) INPUT DEVICE

(75) Inventor: Kazuhito Oshita, Fukushima-ken (JP)

Correspondence Address: BRINKS HOFER GILSON & LIONE, P.O. BOX 10395, CHICAGO, IL, 60610, US

(73) Assignee: ALPS ELECTRC CO., LTD., Tokyo (JP)

(21) Appl. No.: 11/565,435

(22) Filed: Nov. 30, 2006

(30) Foreign Application Priority Data
Dec. 1, 2005 (JP) 2005-348129

(51) Int. Cl. G09G 5/00

(52) U.S. Cl. 345/173

(57) ABSTRACT

A touch pad device has an operating surface configured to receive contact activity, such as contact by a finger or stylus. A detection circuit detects the contact activity and communicates a detection signal to a data processing unit. The data processing unit associates the contact activity with either a first operation or a second operation. The first operation may be a tap and the second operation may be a touch.

### CROSS-REFERENCE TO RELATED APPLICATION

This application claims the benefit of Japanese Patent Application 2005-348129, filed Dec. 1, 2005, which is hereby incorporated herein by reference.

### FIELD OF THE DISCLOSURE

The present disclosure relates to interface devices. In particular, a touch pad device is disclosed that distinguishes between different types of contact activity.

### BACKGROUND

In a touch pad type input device, the movement of a pointer (cursor) corresponds to the movement of an object on an operating surface. Such a touch pad has a tap function, a touch function, and the like. The tap function is used to run a specific application when a predetermined region on an operating surface is tapped. The touch function is used to perform a specific function when a predetermined region on an operating surface is touched (an operator's finger is placed on the operating surface for a predetermined time or more and then is come off from the operating surface).

JP-A-10-149254 discloses an input device having the above-described functions.

When the tap function and the touch function are mixedly used, a tap operation needs to be distinguished from a touch operation. However, in the related art, it is difficult to clearly distinguish the tap operation and the touch operation.

For this reason, an input device according to the related art generally has either the tap function or the touch function.

In addition, it is necessary to divide one operating surface into a tap operation region and a touch operation region. Accordingly, when an unskilled operator uses the input device, operationality is not good.

### SUMMARY OF THE INVENTION

The present invention is defined by the claims and nothing in this section should be taken as a limitation on those claims.

According to an aspect of the invention, a touch pad device has an operating surface configured to receive contact activity, such as contact by a finger or stylus. A detection circuit detects the contact activity and communicates a detection signal to a data processing unit. The data processing unit associates the contact activity with either a first operation or a second operation. The first operation may be a tap and the second operation may be a touch.

The preferred embodiments will now be described with reference to the attached drawings.

### BRIEF DESCRIPTION OF THE DRAWINGS

FIG. 1 is a perspective view of a notebook personal computer on which a pad type input device is mounted;

FIG. 2 is a partially enlarged plan view showing an operating surface of the pad type input device incorporated in the personal computer shown in FIG. 1;

FIG. 3 is a plan view of a sensor substrate that constitutes the pad type input device;

FIG. 4 is a circuit diagram of the pad type input device shown in FIG. 2;

FIG. 5 is a flowchart showing the operation of an input operation judgment processing according to an embodiment of the invention; and

FIG. 6 is a flowchart corresponding to the operation common to Steps ST20A and ST20B shown in FIG. 5, and showing an input operation judgment and allocation function execution processing routine.

### DESCRIPTION OF THE PRESENTLY PREFERRED EMBODIMENTS

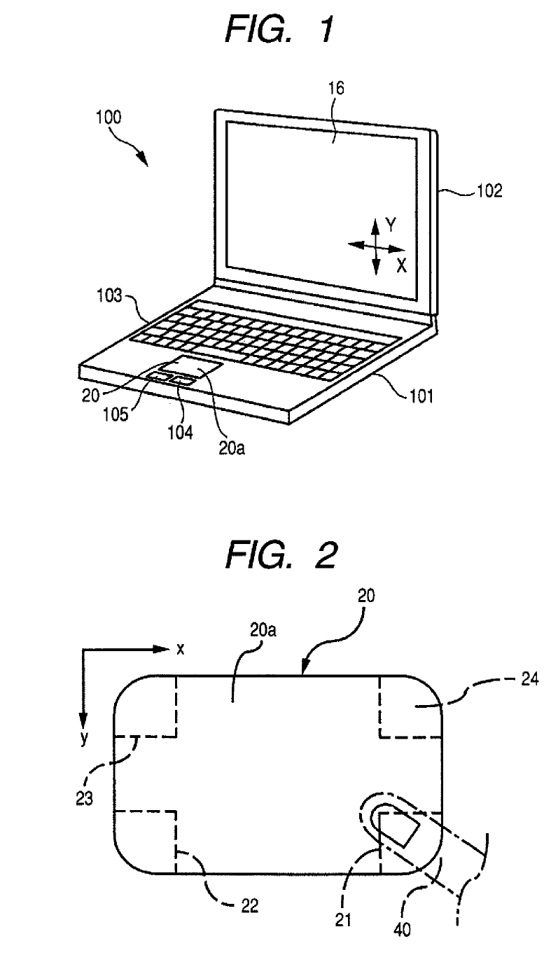

FIG. 1 is a perspective view of a notebook personal computer 100 having a pad type input device 20. The notebook personal computer 100 includes a main body 101 and a display case 102 having a display unit 16. The main body 101 includes a keyboard device 103 serving as an operating device. As shown in FIGS. 1 and 2, the main body 101 includes the pad type input device (touch pad) 20 serving as an input device according to an embodiment of the invention. A right press button (right click button) 104 and a left press button (left click button) 105 are provided in the vicinity of the pad type input device 20.

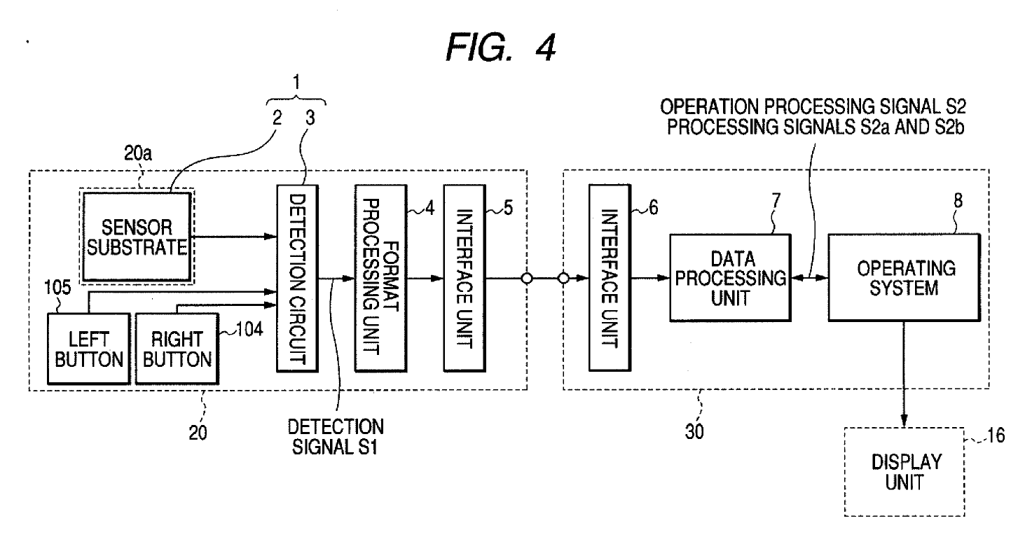

The keyboard device 103 includes a plurality of keys and keyboard switches that detect operations of the individual keys. Operation signals of the individual keyboard switches are supplied to a data processing unit 7 of a main body control unit 30 shown in FIG. 4 through a processing circuit (not shown).

As shown in FIG. 2, the pad type input device 20 includes an operating surface 20a. A coordinate detection mechanism 1, shown in FIG. 4, is provided below the operating surface 20a. The coordinate detection mechanism 1 has a sensor substrate 2 and a detection circuit 3. The operating surface 20a may be any shape. In the embodiment shown in FIG. 2, the operating surface 20a is a rectangle.

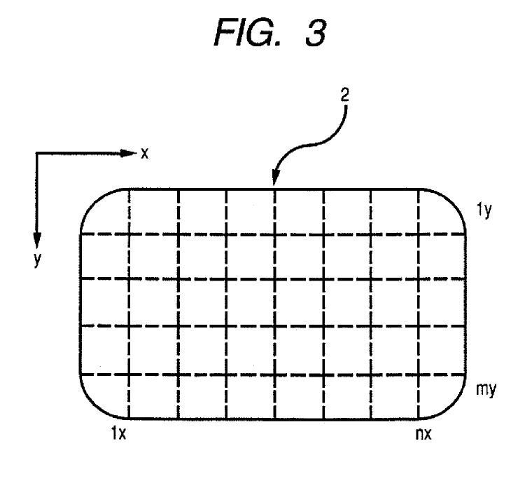

As shown in FIG. 3, the sensor substrate 2 that forms a part of the coordinate detection mechanism 1 includes a plurality of x electrodes 1x to nx (where n is a positive integer) arranged in parallel with one another and in a horizontal direction (x direction in FIG. 3) by predetermined pitches. The coordinate detection mechanism 1 also includes a plurality of y electrodes 1y to my (where m is a positive integer) arranged in parallel with one another and in a vertical direction (y direction in FIG. 3) by predetermined pitches. The plurality of x electrodes 1x to nx are perpendicular to the plurality of y electrodes 1y to my. The sensor substrate 2 includes a dielectric material, having a predetermined capacitance, in communication with the plurality of x electrodes and the plurality of y electrodes. In operation, a first electrical charge is sequentially supplied from a control driving unit (not shown) to the plurality of x electrodes 1x to nx through a vertical scanning unit (not shown). A second electrical charge is sequentially supplied from a control driving unit (not shown) to the plurality of y electrodes 1y to my through a horizontal scanning unit (not shown).

A protective layer is provided on the operating surface 20a to cover the sensor substrate 2. When an operating body 40 formed of a conductor, such as a person's finger or a touch pen, contacts a region on the operating surface 20a through the protective layer, the electrical charge and voltage between the x electrodes 1x to nx and the y electrodes 1y to my proximate the region changes.

The detection circuit 3 detects positional information of the operating body 40 on the basis of the change in voltage and outputs a detection signal S1. The detection signal S1 is converted into a predetermined format by a format processing unit 4 and transmitted from an interface unit 5 through an interface unit 6 to a data processing unit 7.

The data processing unit 7 is configured to execute driver software for input operation judgment. The data processing unit 7 is also configured to calculate positional information, time information, and the like of the operating body 40 on the basis of the detection signal S1 received from the detection circuit 3. The data processing unit 7 generates an operation processing signal S2 having the positional information, time information, and the like. The operation processing signal S2 is supplied to an operating system (OS) 8.

In the present embodiment, the data processing unit 7 is configured to detect whether the input operation of the operating body 40 on the operating surface 20a is the tap operation (first operation), the touch operation (second operation), or other operations (for example, slide operation) on the basis of the operation processing signal S2.

Here, the ‘tap operation’ as the first operation means an instantaneous operation having a time at which the operating body 40 is in contact with the operating surface 20a, that is, a contact time t satisfying the relationship 0<t<T (where T is a predetermined threshold time).

The ‘touch operation’ as the second operation means an operation having a contact time t that is greater than or equal to T (T≦t or T<<t). That is, upon comparison of the contact time t and the predetermined threshold time T, when the contact time t is shorter than the predetermined threshold time T (T>t), the operation by the operating body 40 is judged as the ‘tap operation’. When the contact time t is equal to or longer than the predetermined threshold time T (T≦t), preferably, when the contact time t is significantly longer than the predetermined threshold time T (T<<t), the operation by the operating body 40 is judged as the ‘touch operation’. The slide operation included in other operations means an operation that the operating body 40 moves (slides) on the operating surface 20a while contacting the operating surface 20a.

Preferably, the predetermined threshold time T is freely assigned using software, if necessary.

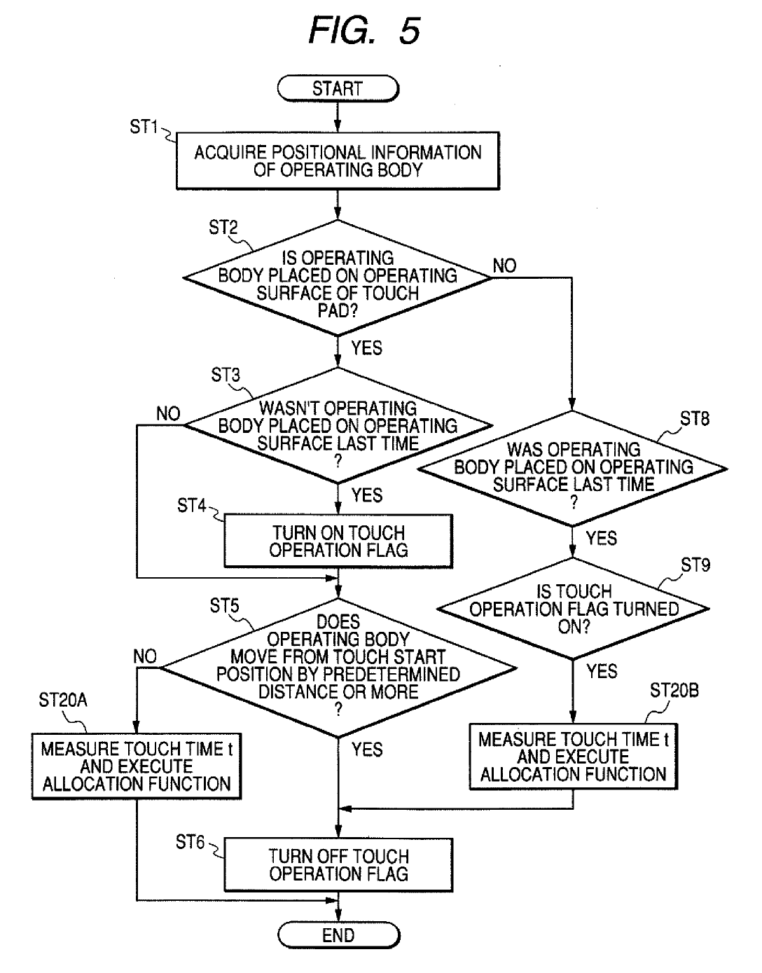

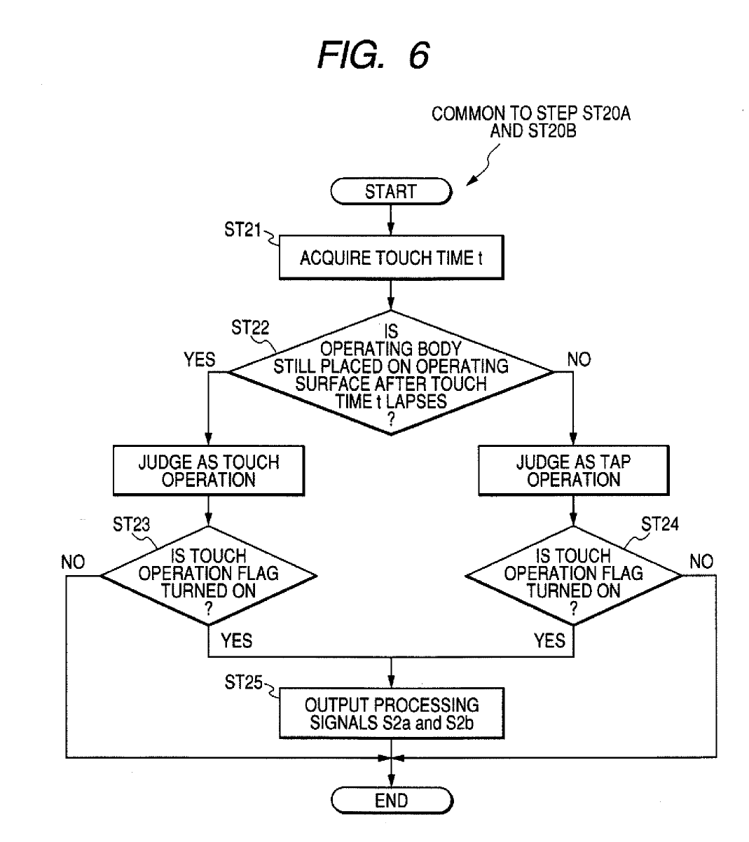

FIG. 5 is a flowchart showing the operation of input operation judgment processing according to an embodiment of the invention. FIG. 6 is a flowchart corresponding to the operation common to Steps ST20A and ST20B of FIG. 5. In the Figures, each step in the process is identified by a numeral attached behind ‘ST’, such as ‘ST1’.

First, the data processing unit 7 acquires the positional information of the operating body 40 on the operating surface 20a and a time at which the detection signal S1 is acquired (Step ST1), and determines whether the operating body 40 is in contact with the operating surface 20a (Step ST2). The determination is based upon the operation processing signal S2 calculated by the data processing unit 7 based upon S1 received from the detection circuit 3.

If it is determined that the operating body 40 is in contact with the operating surface 20a, the process progresses to Step ST3 indicated by ‘YES’. At Step ST3, a positional information flag is checked. The positional information flag indicates whether the operating body 40 was in contact with the operating surface 20a in the last operation. When the positional information flag is set, it represents that the operating body 40 was in contact with the operating surface 20a in the last operation. When the positional information flag is not set (clear state), it represents that the operating body 40 was not in contact with the operating surface 20a in the last operation.

When the judgment result at Step ST3 is ‘YES’, that is, when the operating body 40 was not in contact with the operating surface 20a in the last operation (non-set state), the process progresses to Step ST5 through Step ST4. When the judgment result at Step ST3 is ‘NO’, that is, when the operating body 40 was in contact with the operating surface 20a in the last operation (set state), the process jumps to Step ST5.

At Step ST4, a touch operation flag is set to ‘ON’. Here, the touch operation flag represents whether the execution of a function allocated according to the content of the input operation (touch operation or tap operation) is ‘allowed’ or is ‘not allowed’. When the execution of the function is allowed, the touch operation flag is set to ‘ON’ (set state). When the execution of the function is not allowed, the touch operation flag is set to ‘OFF’ (non-set state).

Further, at Step ST4, the touch operation flag is set to ‘ON’, and simultaneously the positional information of the operating body 40 on the operating surface 20a acquired at Step ST1 and an acquisition time of the detection signal S1 are stored in a memory (not shown) as information when the operating body 40 initially contacts the operating surface 20a.

At Step ST5, it is determined whether the operating body 40 moved a predetermined distance or more from an initial point of contact on the operating surface 20a. That is, at Step ST5, the positional information of the operating body 40, stored in the memory at Step ST4, when the operating body 40 initially contacts the operating surface 20a is compared with the positional information of the operating body 40 acquired at Step ST1. For example, a movement distance is calculated from the positional information included in both signals, then the calculated movement distance is compared with a predetermined reference value, and subsequently a determination is made as to whether the movement distance exceeds the reference value.

For example, when the plurality of electrodes 1x to nx and the plurality of electrodes 1y to my divide an area in the operating surface 20a into a plurality of regions, a region when a center coordinate of the operating body 40 is initially detected (a region including a reference position) is compared with a region where the center coordinate of the operating body 40 is located after a predetermined time lapses, and then a determination is made as to whether the operating body 40 remains in the same region or in a predetermined region in that neighborhood.

In this case, as the predetermined region, it is preferable to secure a predetermined allocation region on the operating surface 20a. It is further preferable to secure at least one corner among a plurality of corners 21, 22, 23, and 24, on the operating surface 20a as the allocation region. As such, if the predetermined allocation region is secured, an input operation position is limited, and thus the input operation can be reliably distinguished. It is preferable for the data processing unit 7 to intensively manage data on the corners. Then, the amount of information to be processed by the data processing unit 7 is reduced and processing speed is improved.

When the predetermined allocation region cannot be provided at the corners, the predetermined allocation region may be distinguished from other regions by dividing the operating surface by colors or by attaching unevenness to the operating surface.

If the determination at Step ST5 is ‘YES’ (when the operating body moves by the predetermined distance or more), the process progresses to Step ST6, the touch operation flag is set to the non-set state (‘OFF’) that does not allow the execution of the function allocated to the input operation, and then the process progresses to ‘END’. That is, if it is determined that the operating body 40 moved the predetermined distance or more, corresponding to a slide operation, the function allocated to the tap operation or the touch operation is not executed. Then, the touch operation flag is set to ‘OFF’, and the process waits for a next operation.

Meanwhile, at Step ST5, if it is determined that the movement of the operating body 40 is in a predetermined region from the position on the operating surface 20a, at which the operating body 40 initially touches, not the slide operation, that is, when the determination is ‘NO’, the process progresses to the touch operation judgment and allocation function execution processing routine shown in the flowchart in FIG. 6.

As shown in FIG. 6, the data processing unit 7 acquires the touch time t (Step ST21). That is, the data processing unit 7 acquires, as the touch (contact) time t, a difference between the time information, stored in the memory at Step ST4, when the operating body 40 initially contacts the operating surface 20a and the time information when the detection signal S1 is acquired at Step ST1 (Step ST21).

At Step ST22, like Step ST2, it is determined whether the operating body 40 is in contact with the operating surface 20a. When the operating body 40 is in contact with the operating surface 20a after the touch time t lapses, that is, when the judgment result is ‘YES’, the operation by the operating body 40 is judged as the touch operation and the process progresses to Step ST23. When the operating body 40 is not in contact with the operating surface 20a after the touch time t lapses, that is, when the judgment result is ‘NO’, the operation by the operating body 40 is judged as the tap operation and the process progresses to Step ST24.

At Steps ST23 and ST24, it is determined whether the touch operation flag is set to ‘ON’ (set state) or ‘OFF’ (non-set state). At this time, when the judgment result is ‘YES’ (when a set state is ‘ON’), the data processing unit 7 outputs the processing signal S2a or S2b so as to execute the function allocated to the touch operation or the function allocated to the tap operation (Step ST25).

When the touch time t acquired at Step ST21 is longer than the predetermined threshold time T (T<t), the data processing unit 7 outputs the first processing signal S2a so as to execute the function allocated to the touch operation. When the touch time t acquired at Step ST21 is shorter than the predetermined threshold time T (0<t<T), the data processing unit 7 outputs the second processing signal S2b so as to execute the function allocated to the tap operation (Step ST25). After Step ST25, the process progresses to ‘END’ (Step ST26).

The first processing signal S2a or the second processing signal S2b is transmitted to the operating system (OS) 8 such that a processing corresponding to each signal is performed in the operating system 8. For example, the first processing signal S2a based on the touch operation may be allocated to a main button of a mouse operation and the second processing signal S2b based on the tap operation may be allocated to a sub button of the mouse operation.

When the first processing signal S2a based on the touch operation is input, word processing application software runs. When the second processing signal S2b based on the tap operation is input, spreadsheet application software runs.

Meanwhile, at Steps ST23 and ST24, if it is determined that the touch operation flag is set to ‘NO’ (non-set state, that is, ‘OFF’), because the function allocated to the touch operation or the tap operation is not executed, the process progresses to ‘END’ of FIG. 6 through the ‘END’ of FIG. 5 and waits for a next operation.

When the result of Step ST2 is ‘NO’ (when the operating body 40 is not placed on the operating surface 20a), the process progresses to Step ST8. At Step ST8, the positional information flag of the operating body 40 is checked in the same manner as Step ST3.

When the result of Step ST8 is ‘YES’ (when the operating body 40 is placed on the operating surface 20a), the process progresses to Step ST9. If the result of Step ST8 is ‘NO’ (when the operating body 40 was placed on the operating surface 20a in the last operation), the process progresses to Step ST6.

At Step ST9, it is determined whether the touch operation flag is set. If it is set, the process progresses to Step ST20B and the same processing as Step ST20A is performed.

Even if the operating body 40 is not in contact with the operating surface 20a, if it is determined that the operating body 40 was in contact with the operating surface 20a in the last operation, the state of the touch operation flag is checked, and the touch time t is acquired on the basis of data upon the last operation. Therefore, it is possible to perform the judgment processing of the same input operation when the operating body 40 is placed on the operating surface 20a. Then, various processings are performed according to the judgment of the input operation.

Although one allocation region is provided in this embodiment, the invention is not limited thereto. A function to be performed according to the touch operation or the tap operation may be allocated for each allocation region.

For example, if the touch operation is performed at a first corner 21 shown in FIG. 2, a function may be allocated such that word processing application software runs and, if the tap operation is performed, a function may be allocated such that spreadsheet application software runs. If the touch operation is performed at a second corner 22, a function may be allocated such that an organizer runs and, if the tap operation is performed, a function may be allocated such that an address book runs. If the touch operation is performed at a third corner 23, a function may be allocated such that map information application software runs and, if the tap operation is performed, a function may be allocated such that an Internet browser runs and the connection to a predetermined web page is made.

Application software allocated at each corner may be freely set or changed using other software.

Further, for example, when the touch operation is performed at the first corner 21, a multi-icon including a group of small icons that indicate application software may be displayed in a thumbnail form. Further, the touch operation may be performed for a pointer (cursor) that overlaps one small icon included in the multi-icons, thereby running application software corresponding to the small icon.

In the input device according to the embodiment of the invention, a different processing operation can be performed in a computer or the like on the basis of the content of the input operation (touch operation or tap operation) of the operating body. Therefore, an input device having excellent operationality can be provided.

While various embodiments of the invention have been described, it will be apparent to those of ordinary skill in the art that many more embodiments and implementations are possible within the scope of the invention.

Accordingly, the invention is not to be restricted except in light of the attached claims and their equivalents.

1. An apparatus comprising:
an operating surface to receive contact activity;
a detection circuit to detect the contact activity; and
a data processing unit to receive a contact activity detection signal from the detection circuit and associate the contact activity with either a first operation or a second operation, different from the first operation.

2. The apparatus of claim 1 wherein the contact activity detection signal is based upon the duration of the contact activity.

3. The apparatus of claim 1 wherein the first operation is a tap operation and the second operation is a touch operation.

4. The apparatus of claim 1 further comprising an allocation region on the operating surface to receive the contact activity.

5. The apparatus of claim 4 wherein the allocation region is provided at a corner of the operating surface.
